(19) United States
(12) Patent Application Publication
(10) Pub. No.: US 2004/0070592 A1
(43) Pub. Date: Apr. 15, 2004

(54) System and method for processing digital pictures

(76) Inventors: Pascal Lucien Michel Dangin, Amagansett, NY (US); Sebastian Replanski, New York, NY (US)

Correspondence Address: Patterson Belknap Webb & Tyler, LLP, Attention: I.P. Docketing, 1133 Avenue of the Americas, New York, NY, 10036, US

(21) Appl. No.: 10/268,542

(22) Filed: Oct. 10, 2002

(51) Int. Cl. G09G 5/00

(52) U.S. Cl. 345/716

(57) ABSTRACT

A system and method for processing digital pictures is disclosed. The system and method allow a user to use traditional dark-room-type techniques with digital photographs. The system and method allow for the batch processing of multiple images based on a user's preferences indicated on a single picture. The system and method provide a portable digital picture processing station.

### CROSS-REFERENCE TO CD-R APPENDIX

An Appendix containing a computer program listing is submitted on a compact disk, which is herein incorporated by reference in its entirety. The total number of compact disks, including duplicates, is two. The files contained on the compact disk include: (1) the directory “Colorwork” with the following files: backgroundView.h (1K, Oct. 8, 2002); backgroundView.m (1K, Oct. 8, 2002); CurveView.h (2k, Aug. 26, 2002); CurveView.m (16K, Sep. 25, 2002); filterDocumentView.h (1K, Sep. 10, 2002); filterDocumentView.m (2K, Sep. 13, 2002); filterObjectCurves.h (2K, Oct. 8, 2002); filterObjectCurves.m (10K, Oct. 8, 2002); filterObjectSaturation.h (2K, Oct. 8, 2002); filterObjectSaturation.m (11K, Sep. 13, 2002); filterUnit.h (1K, Oct. 8, 2002); filterUnit.m (2K, Oct. 8, 2002); filterView.h (1K, Oct. 8, 2002); filterView.m (7K, Oct. 8, 2002); filterViewRep.h (1K, Oct. 8, 2002); filterViewRep.m (6K, Oct. 8, 2002); gradient.h (1k, Aug. 26, 2002); gradient.m (1k, Aug. 26, 2002); henry.pbxuser (22K, Oct. 8, 2002); histogram.h (1K, Oct. 8, 2002); histogram.m (3K, Oct. 8, 2002); main.m (1K, Oct. 8, 2002); myController.h (6K, Oct. 8, 2002); myController.m (49K, Oct. 6, 2002); project.pbxproj (19K, Oct. 8, 2002); seb.pbxuser (11K, Oct. 8, 2002); wb02a.pbxuser (87K, Oct. 8, 2002); wbImageView.h (2k, Aug. 26, 2002); wbImageview.m (7k, Aug. 26, 2002); (2) the directory “Boxwork” with the following files: applyColorFunctions.java (1K, Oct. 8, 2002); controller.java (26K, Oct. 7, 2002); henry.pbxuser (10K, Oct. 8, 2002); importController.java (41K, Oct. 7, 2002); jdirectFunctions.java (2K, Oct. 8, 2002); main.m (2K, Oct. 7, 2002); myImageView.java (3K, Oct. 8, 2002); project.pbxproj (17K, Oct. 8, 2002); seb.pbxuser (75K, Oct. 8, 2002); shootDataSource.java (9K, Oct. 8, 2002); wb02a.pbxuser (23K, Oct. 8, 2002); (3) the directory “Editwork” with the following files: applyColorFunctions.java (1k, Aug. 27, 2002); controller.java (77K, Oct. 17, 2002); henry.pbxuser (9K, Oct. 8, 2002); imageCell.java (6K, Oct. 8, 2002); imageMatrix.java (7K, Oct. 8, 2002); jdirectFunctions.java (2k, Aug. 15, 2002); main.m (1K, Oct. 8, 2002); project.pbxproj (10K, Oct. 8, 2002); seb.pbxuser (30K, Oct. 8, 2002); sreplans.pbxuser (11K, Oct. 8, 2002); wb02a.pbxuser (81K, Oct. 8, 2002); (4) the directory “WBSharedLib” with the following files: AEProcessor.c (6K, Jul. 22, 2002); KPDCLoader.h (4K, Jul. 22, 2002); KPDCLoader_Mac copy.c (12K, Jul. 22, 2002); KPDCLoader_Mac.c (8K, Jul. 22, 2002); KPDCLoaderFuncTypes.h (6K, Jul. 22, 2002); KPDCSampleGetRectangle.c (88K, Jul. 22, 2002); KPDCSampleGetRectangle.h (5K, Jul. 22, 2002); KProDCSDK.h (28K, Jul. 22, 2002); KProDCSDKCameraErrors.h (8K, Jul. 22, 2002); KProDCSDKErrors.h (8K, Jul. 22, 2002); KProDCSDKTypes.h (32K, Jul. 22, 2002); logger.c (1K, Jul. 22, 2002); logger.h (1K, Jul. 22, 2002); MacSampleGetRectangle.c (10K, Jul. 22, 2002); PrefixPro3SLR.h (1K, Jul. 22, 2002); PrefixProBack.h (1K, Jul. 22, 2002); sharedlib.h (1K, Jul. 22, 2002); Tiffsave.c (14K, Jul. 22, 2002); tiffsave.h (54K, Jul. 22, 2002); (5) the directory “Pagework” with the following files: henry.pbxuser (560K, Oct. 8, 2002); myImageViewDouble.java (11K, Oct. 8, 2002); myImageViewSingle.java (14K, Oct. 8, 2002); myImageViewSingle2.java (18K, Oct. 8, 2002); myPanel.java (1K, Oct. 8, 2002); myPanel3.java (1K, Oct. 8, 2002); myPrintedDoublePage.java (4K, Oct. 8, 2002); myPrintedPage.java (3K, Oct. 8, 2002); myPrintedStoryboardPage.java (10K, Oct. 8, 2002); project.pbxproj (25K, Oct. 8, 2002); Sketch_main.m (1K, Oct. 8, 2002); SKTCircle.java (1K, Oct. 8, 2002); SKTDrawAppDelegate.java (23K, Oct. 8, 2002); SKTDrawDocument.java (42K, Oct. 8, 2002); SKTDrawWindowController.java (17K, Oct. 8, 2002); SKTGraphic.java (40K, Oct. 8, 2002); SKTGraphicView.java (74K, Oct. 8, 2002); SKTGridPanelController.java (6K, Oct. 8, 2002); SKTGridView.java (1K, Oct. 8, 2002); SKTImage.java (14K, Oct. 8, 2002); SKTInspectorController.java (19K, Oct. 8, 2002); SKTLine.java (4K, Oct. 8, 2002); SKTRectangle.java (1K, Oct. 8, 2002); SKTRenderingView.java (2K, Oct. 8, 2002) SKTTextArea.java (14K, Oct. 8, 2002); SKTToolPaletteController.java (3K, Oct. 8, 2002); wb02a.pbxuser (5K, Oct. 8, 2002); and (6) the directory “WBApplyColorLib” with the following files: applyColor.h (1k, Aug. 20, 2002); applyColor.m (3k, Aug. 20, 2002).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Digital photography eliminates the film exposure, processing, and scanning that is required for traditional, film-based photography. Nonetheless, digital photography has been limited by the available post-production tools. In the absence of traditional film exposure, processing, and scanning, the ability to control the look of the final photographic print is limited by the digital tools available to the photographer. The system and methods disclosed herein provide digital developing tools that allow for great freedom and creativity in modifying the appearance of digital photographs, much as the traditional darkroom tools allow for film-based pictures.

### BRIEF SUMMARY OF THE INVENTION

It is an object of the present invention to provide a digital developing tool that allows a user to modify the appearance of a digital photograph.

It is a further object of the present invention to provide a system and method for allowing a user to modify digital photographs using digitally implemented techniques akin to techniques used to modify traditional, film-based photographs in a traditional darkroom.

It is a further object of the present invention to provide a system and method for making changes to a set of digital pictures based on changes made to a single picture.

It is a further object of the present invention to provide a digital developing tool which is portable.

It is a further object of the present invention to provide a digital developing tool for use at the same location as a photo shoot.

It is a further object of the present invention to provide a system for simultaneously viewing multiple modifications of a single digital picture.

It is a further object of the present invention to provide a data structure for storing a mapping of color information for the batch processing of multiple digital pictures.

It is a further object of the present invention to provide simultaneous representations of multiple color curves.

The above and other objects are achieved by a portable computer system adapted and programmed to process digital pictures.

### BRIEF DESCRIPTION OF THE DRAWINGS

The invention is illustrated in the figures of the accompanying drawings which are meant to be exemplary and not limiting, in which like references refer to like or corresponding parts, and in which:

FIG. 1 is a perspective view of a preferred embodiment of the present invention from the front;

FIG. 2 is a perspective view of a preferred embodiment of the present invention from the rear-side;

FIG. 3 is a rear view of a preferred embodiment of the present invention;

FIG. 4 is a perspective view of a preferred embodiment of the present invention from the front-side, with computer 10 partially removed from housing 140;

FIG. 5 is a perspective view of a preferred embodiment of the present invention from the front, showing the device in its shipping configuration;

FIG. 6 is a perspective view of a preferred embodiment of the present invention from the front-side, showing the device in its shipping configuration;

FIG. 7 is a screen shot of a preferred embodiment of the present invention, showing a screen display of the “Boxwork” module;

FIG. 8 is a screen shot of a preferred embodiment of the present invention, showing a screen display of the “Boxwork” module;

FIG. 9 is a screen shot of a preferred embodiment of the present invention, showing a screen display of the “Colorwork” module;

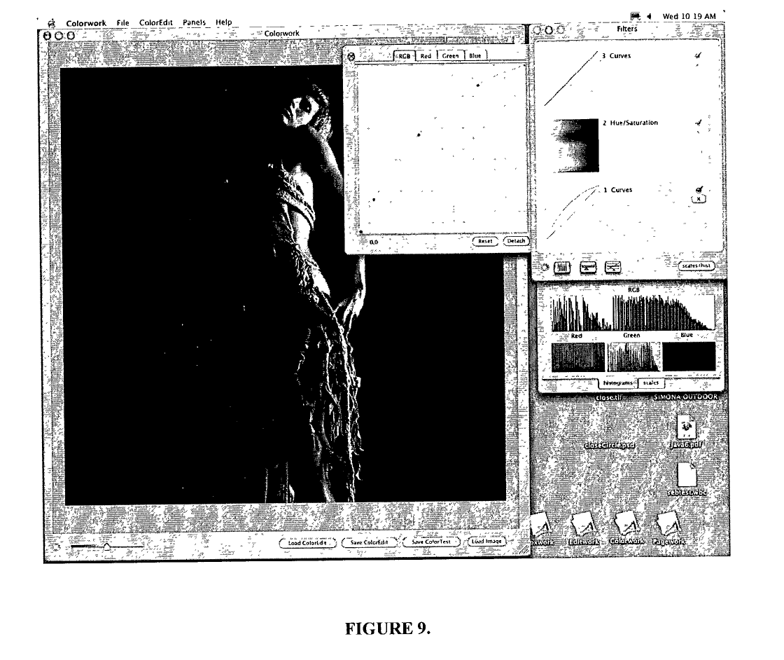

FIG. 10 is a screen shot of a preferred embodiment of the present invention, showing a screen display of the “Editwork” module; and

FIG. 11 is a screen shot of a preferred embodiment of the present invention, showing a screen display of the “Pagework” module.

### DETAILED DESCRIPTION OF THE PREFERRED EMBODIMENTS

Conventional still-picture film cameras, such as the Mamiya RZ67 or the Hasselblad 555 ELD body can be equipped with digital backs. Traditionally, the back of a camera contains a roll of film. When modified to take digital pictures, the traditional back is replaced by a charge-coupled device (“CCD”) array and associated electronics. The CCD array comprises red, green, and blue cells, with each cell being sensitive to a corresponding wavelength-range of light. For example, the red cells are sensitive to cyan light emissions, the green cells to magenta light emissions, and the blue cells to yellow light emissions. The cells produce a voltage corresponding to the intensity of the light incident on the cells.

These voltages are converted to binary data (bits), which are then written to a storage medium. The storage medium may be any suitable medium, such as a recordable CD-ROM, flash memory, CompactFlash memory, a SmartMedia card, a SecureDigital card, an IBM microdrive disc, a floppy disc, a Sony MemoryStick, a MultiMedia card, etc. The data are written to the storage medium in the form of a simple file which lists all the values for each channel (red, green and blue) one after the other. This file is often in a format proprietary to the maker of the digital capture device.

After the data file has been created and stored, it is generally read into a computer, such as an IBM-PC compatible or Apple MacIntosh compatible computer, for further processing and possible archiving. Appropriate software is necessary to interpret the data file. For example, Capture Studio software (available from Eastman Kodak Co., Rochester, N.Y.) reads the values stored in the data file and interprets them so that the computer can display the picture. Computers typically use a system of 8 bits which allows for 256 shades of gray for each of the three color channels (red, green, blue), resulting in approximately 16 million possible colors (i.e., (256 possible shades of red)×(256 possible shades of green)×(256 possible shades of blue)=16,777,216 total color combinations). The three channels are all defined as a gray image mapping of each color. Merging these three channels of data produces a color image.

Software capable of interpreting these color values is available from a number of companies such as Adobe Systems Inc. (San Jose, Calif.) and Eastman Kodak. The conversion of these color values (also referred to as “profiles”) is the process of mapping color from the camera's CCD array to the computer's output device, such as a monitor screen or printer. One problem with such software programs is that the manufacturers have pre-determined how colors should be mapped and interpreted. While this interpretation process is intricate and comprehensive, the software companies have chosen to approach it in a very generic way, overlooking individual photographers' artistic aspirations. In a sense, these companies are attempting to replicate the analog world of conventional photography using rules not applicable to the digital process, leaving very little control and flexibility over a photographers' digital image. Photographers are typically unhappy with the unchangeable, generic look of digital photography. All digital images have the tendency to look the same regardless of who is taking the picture and despite the hours of effort invested in lighting.

This process negates the underlying reason photographers are moving to digital processes. Photographers want to shoot digitally but have the same kind of freedom and control over their work they were able to achieve in their traditional dark-room with film-based photography, but the current technology's pre-determined mapping limits photographers' control. There are programs to manipulate these profiles (such as Profile Maker, available from Gretag MacBeth, New Windsor, N.Y.), but such manipulation is cumbersome with these programs.

Using traditional, film-based methods, a photographer can shoot an image on negative film and produce a print from the negative. When a shoot is completed, the photographers' clients are concerned with the way the final print looks; they are generally not concerned with the look of the negative. Yet without the negative, the print cannot be created. The invention disclosed herein applies the same concept to digital photography: a photographer can shoot a picture which produces a file; from the data in the file a print can be produced. Digital photography is fundamentally the same process as traditional photography, and there is a parallel need for an intermediate process that is analogous to the negative film.

The invention disclosed herein eliminates the predefined digital looks which heavily damage the integrity of photographers' digitally shot images and realizes the parallels between film negatives and the data files produced by digital cameras. While a film negative looks orange to the naked eye, the negative is the source material and contains all the information photographic papers “understand” when a print is made from the negative.

A comparison can be drawn from within the digital process. The file captured by the camera is as strange looking as is a negative to the naked eye, which is why interpretations are needed. In the digital world, the computer screen is equivalent to a print in the film-based world. In the system and methods disclosed herein, the strange looking file from the digital camera (all the data recorded by the camera) is methodically converted into color values using a simple algorithm, bypassing interpretation.

The resulting image from this process is also strange looking to the naked eye; it is very dark without apparent colors, just like a negative. But with color alteration, the dark image can be transformed into a beautiful image, rich in details, free of generic constraints and, most significantly, ready to be manipulated for any look or interpretation. That freedom is why photographers choose to shoot on negative film. It gives them full tonal control over their images, from highlights to shadows. The interpretations that the software companies currently provide lock artists into specific looks, thereby standardizing their work. In essence, these companies are streamlining the process by creating a “point and click” interface, but in the process they are removing the freedom to manipulate colors.

The invention disclosed herein also contains a very clear editing method (such as for choosing final images), which is tailored to photographers' needs. It also includes color control functions and a layout module which lets a user pair images to create storyboards or spreads for advertising campaigns and editorial stories. The software enables the user to place logos and artwork over images (including magazine headlines and titles). In addition, the system contains a job ticketing database that can be coupled to a local or remote network, such as an intranet, to ensure proper organization of jobs.

In a preferred embodiment, the hardware and software is preferably loaded into a console that is portable and which provides a useful workspace to edit the digital pictures.

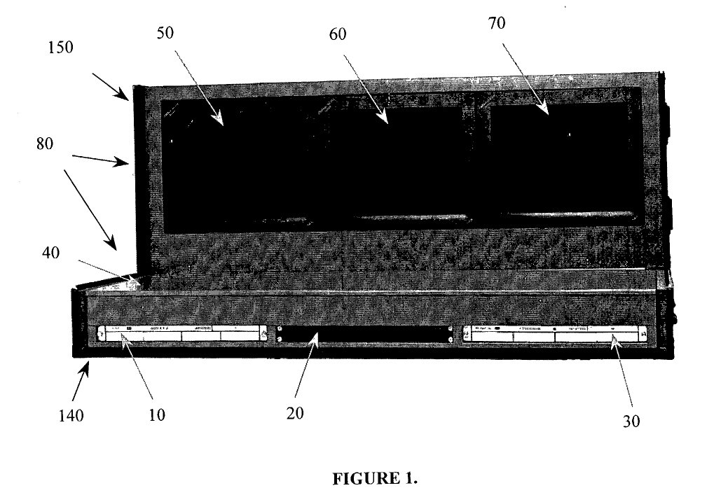

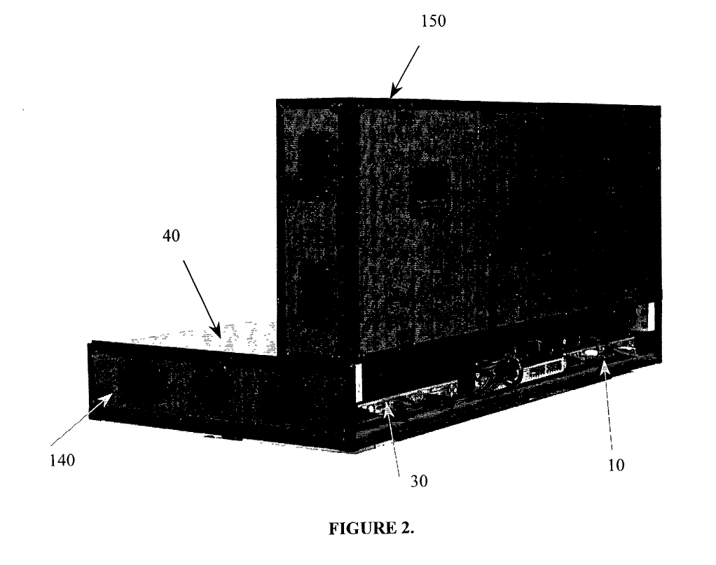

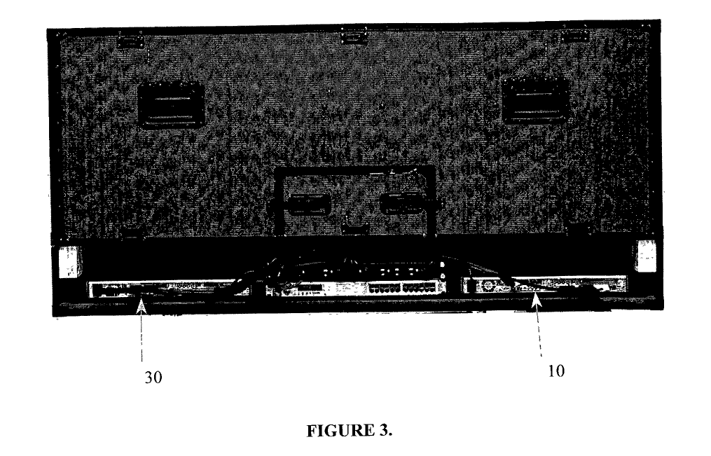

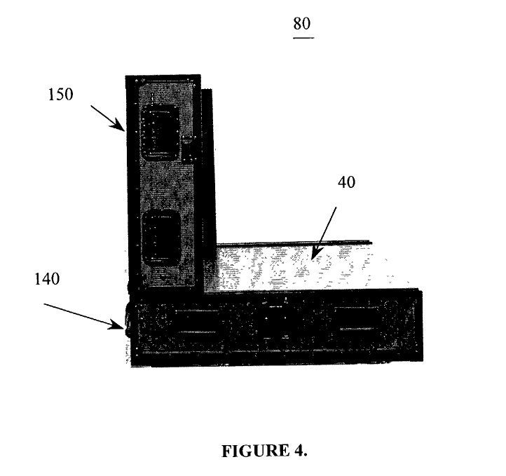

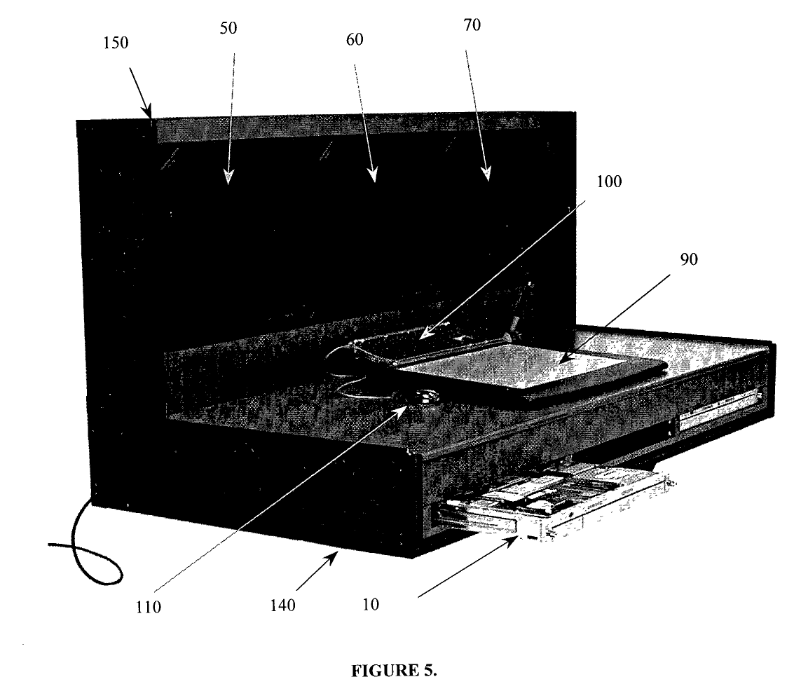

With reference to FIGS. 1-6, a preferred embodiment of the present invention includes one or more general purpose microcomputers 10, 30, such as an Apple MacIntosh Xserve M8628LL/A, one or more monitors 50, 60, 70 such as an NEC MultiSync LCD monitor, and one or more adapters 20 for reading from and/or writing to data storage media, such as a device for reading IBM MicroDrive discs. In a preferred embodiment, the computers, monitors, and adapters are contained in a housing 80, having an upper portion 150 and a lower portion 140, that is configured in a desk-type arrangement to provide a workspace 40 for the users. For example, workspace 40 may be used to hold one or more input devices for the computers, such as keyboards 100, graphics tablets 90, or mice 110, as shown in FIG. 5.

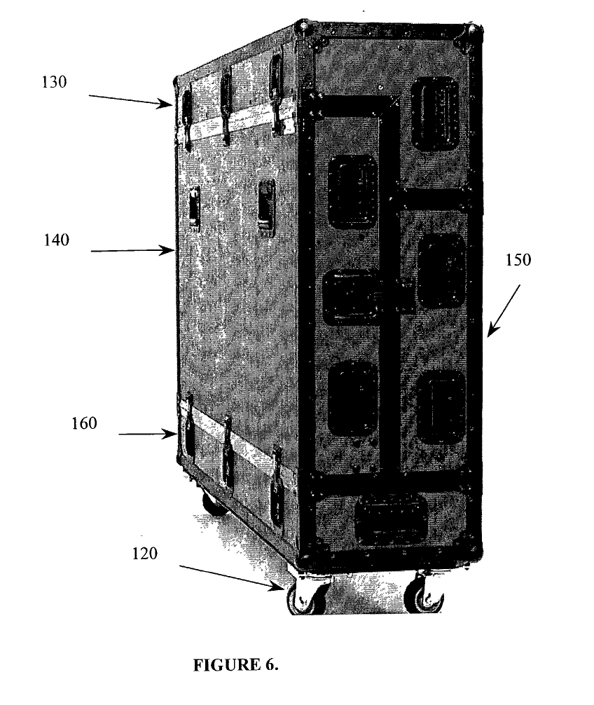

The housing 80 may also be configured to be assembled together with other pieces 130, 160, and casters 120 to form a box for ease of moving and shipping. Pieces 130 and 160 preferably contain storage space for shipping other items along with the digital picture processing system. In such an arrangement, the top portion 150 of the housing 80 is removably connected to the lower portion 140 of the housing 80 at a right angle when the system is in use, as shown in FIGS. 1-5, and removably connected to the lower portion 140 of the housing 80 with flush sides in contact, as shown in FIG. 6, for convenience when the unit is to be shipped or whenever it is desirable to have the housing as compact as possible. Such connection between the upper portion 150 of the housing 80 and the lower portion 140 of the housing 80 may be accomplished with any suitable connection mechanisms, such as rails, glides, tracks, latches, hooks, or hinges, and their corresponding parts.

In a preferred embodiment, the system includes software running on the one or more computers 10, 30. Such software may be broken down into a series of modules and sub-modules. In a preferred embodiment, the software is designed to operate on a MacIntoshcom-patible computer running the Mac OS X operating system (available from Apple). In the preferred embodiment described herein, the software comprises four main modules (Boxwork, Colorwork, Editwork, and Pagework) each of which comprises multiple component programs.

In a preferred embodiment, the source code is written to be compiled with Project Builder (available from Apple, Cupertino, Calif.). The source code provided in the computer program listing Appendix on CD-ROM was written for and compiled with Project Builder version 2.1. The source code was compiled using Project Builder, its built-in Java compiler, and the GCC compiler, version 3.1 (available from Apple, Cupertino, Calif.). As will be apparent to those of skill in the art, those listings incorporating “pbx” in their name are Project Builder source code files; those listings with a suffix of “h” are objective C header files; those listings with a suffix of “m” are objective C source code files; those listings with a suffix of “c” are C source code files; and those listings with a suffix of “java” are Java source code listings. The “headers” and “include” files referred to in the various listings are either set forth in other listings in this disclosure or are the standard, so-named headers supplied by Apple in its Developer's Tools.

While a preferred embodiment has been described with reference to the MacIntosh OS X operating system and the Apple Project Builder development tools, it will be apparent to those skilled in the art that the system and methods disclosed herein may be implemented on any suitable computer with any suitable operating system.

The software of the invention disclosed herein provides a digital developing and production tool for photographers, allowing them to digitally perform all the tasks they currently execute manually, on an easy-to-use, intuitive, digital platform. In a preferred embodiment the software enables photographers to color correct, edit, and layout their images digitally, creating a complete digital workflow.

A photographer will typically shoot hundreds of images for every “final” image to be printed and/or published. For example, a 10-page story for fashion magazine could be culled from thousands of images taken on the day of the shoot.

One of the many tasks photographers and their teams face is the simple and straight forward question: “Do I have the right image?” This issue is best addressed while the photographer is still on location with the entire team (makeup artist, hairstylist, clothing stylist, lighting designer, set designer, etc.).

Digital photography allows the photographer to see the images shot almost instantly. Digital photography bypasses the lengthy process of traditional film developing. In a preferred embodiment of the present invention, images are “developed” in a fraction of the time required by traditional, film-based techniques, permitting photographers to visualize the look of the images almost immediately after s/he has shot a picture.

Digital camera vendors such as Kodak have imposed a color workflow system that locks artists into predetermined “looks,” thereby standardizing photographers' work. The present invention eliminates such predefined digital “looks” which heavily damage the integrity of digitally shot images. The present invention allows a user to manipulate colors, hence providing photographers with the same artistic freedoms they utilize when working in conventional photography.

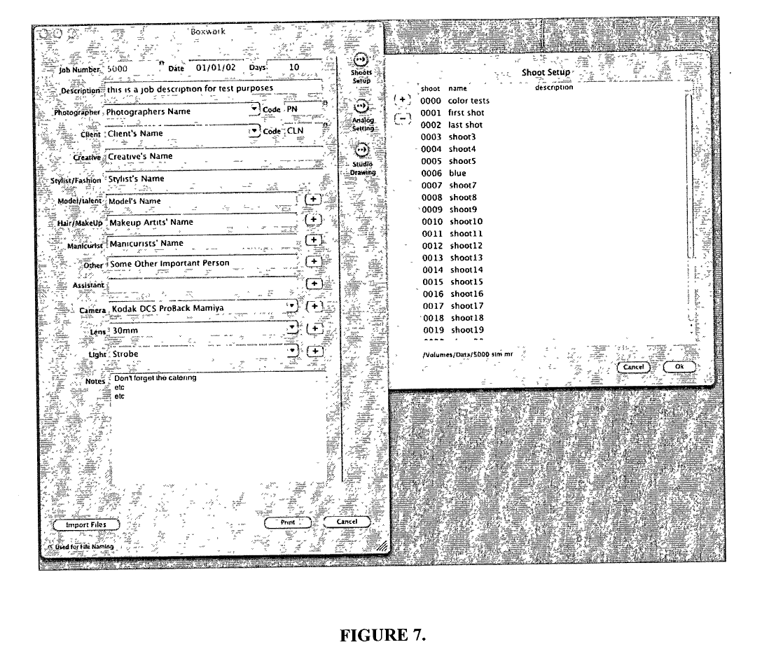

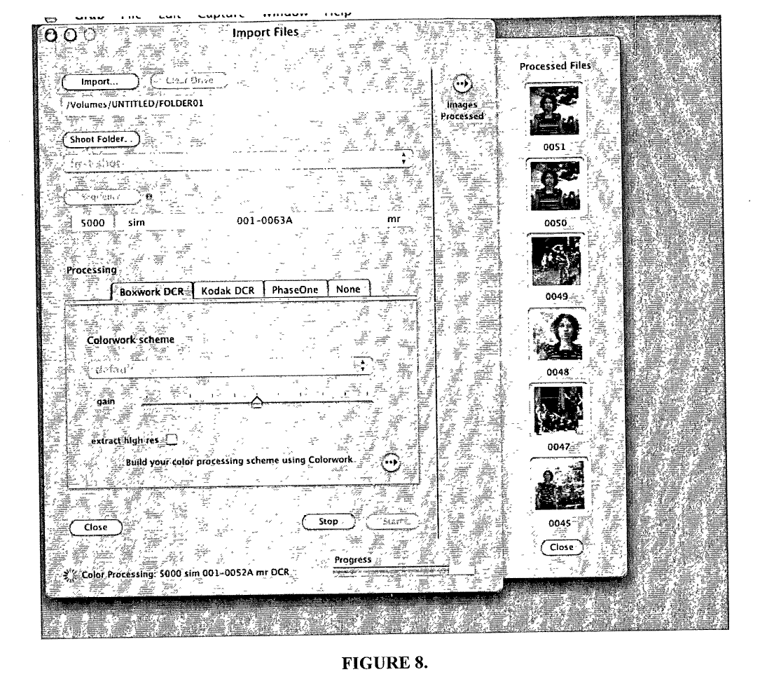

In a preferred embodiment, a “Boxwork” software module is used to organize and manage the overall photography job. FIGS. 7 and 8 are screen shots of a preferred embodiment of the Boxwork software module. The component parts of a preferred embodiment of the Boxwork module are set forth in the “Boxwork” directory of the computer program listing Appendix and include the following source code files: applyColorFunctions.java (1K, Oct. 8, 2002); controller.java (26K, Oct. 7, 2002); henry.pbxuser (10K, Oct. 8, 2002); importController.java (41K, Oct. 7, 2002); jdirectFunctions.java (2K, Oct. 8, 2002); main.m (2K, Oct. 7, 2002); myImageView.java (3K, Oct. 8, 2002); project.pbxproj (17K, Oct. 8, 2002); seb.pbxuser (75K, Oct. 8, 2002); shootDataSource.java (9K, Oct. 8, 2002); wb02a.pbxuser (23K, Oct. 8, 2002). The Boxwork files also may use those programs set forth in the “WBSharedLib” directory of the computer program listing Appendix, including: AEProcessor.c (6K, Jul. 22, 2002); KPDCLoader.h (4K, Jul. 22, 2002); KPDCLoader_Mac copy.c (12K, Jul. 22, 2002); KPDCLoader_Mac.c (8K, Jul. 22, 2002); KPDCLoaderFuncTypes.h (6K, Jul. 22, 2002); KPDCSampleGetRectangle.c (88K, Jul. 22, 2002); KPDCSampleGetRectangle.h (5K, Jul. 22, 2002); KProDCSDK.h (28K, Jul. 22, 2002); KProDCSDKCameraErrors.h (8K, Jul. 22, 2002); KProDCSDKErrors.h (8K, Jul. 22, 2002); KProDCSDKTypes.h (32K, Jul. 22, 2002); logger.c (1K, Jul. 22, 2002); logger.h (1K, Jul. 22, 2002); MacSampleGetRectangle.c (10K, Jul. 22, 2002); PrefixPro3SLR.h (1K, Jul. 22, 2002); PrefixProBack.h (1K, Jul. 22, 2002); sharedlib.h (1K, Jul. 22, 2002); Tiffsave.c (14K, Jul. 22, 2002); tiffsave.h (54K, Jul. 22, 2002). The programs in the WBSharedLib directory of the computer program listing Appendix allow the software modules disclosed herein to access the raw data captured and saved by the Kodak Proback software. These programs use the Kodak Proback SDK, version 1.3, to access these data.

Likewise, the Boxwork module also may use those programs set forth in the “WBApplyColorLib” directory of the computer program listing Appendix, including the following files: applyColor.h (1k, Aug. 20, 2002); applyColor.m (3k, Aug. 20, 2002).

The Boxwork software module allows a user to perform several functions, such as: (1) entering all relevant information into various fields such as the photographer, the client, the model, the hair stylist, the clothing stylist, the location of the shoot, the equipment needed for the shoot, etc.; (2) creating and managing the file system structure for the photo-shoot (i.e., if there are 10 final images for a shoot, the user can create 10 distinct logical groupings of images); (3) copying, renaming, organizing, color correcting, and creating previews of the images in one simple step.

Digital cameras typically use their own file naming convention, making it very difficult for users to quickly and easily organize images. In a preferred embodiment, the present invention comprises a unique file renaming capability. Using the standard digital camera software, users are forced to individually rename each file and manually copy it to an appropriate job folder (ifs/he has even created a job folder for each shot) or to one large repository. One aspect of the present invention automatically names each file with a photo-shoot unique number, a client code, a three-digit shoot number, a four-digit sequence number, and a two-character photographer code (e.g., 10087 CRK 001-0034 MS).

Files are automatically copied to the appropriate location, color processed with the photographer's color scheme (as described in more detail below with reference to the “Colorwork” module), and smaller image previews are created for easier and faster editing and layout (as described in more detail below with reference to the “Editwork” and “Pagework” modules).

In a preferred embodiment, a “Colorwork” module is used to create different “looks” or color schemes for a particular photo shoot. FIG. 8 is a screen shot of a preferred embodiment of the Colorwork module. The component parts of a preferred embodiment of the Colorwork module are set forth in the “Colorwork” directory of the computer program listing Appendix and include the following source code files: backgroundView.h (1K, Oct. 8, 2002); backgroundView.m (1K, Oct. 8, 2002); CurveView.h (2k, Aug. 26, 2002); CurveView.m (16K, Sep. 25, 2002); filterDocumentView.h (1K, Sep. 10, 2002); filterDocumentView.m (2K, Sep. 13, 2002); filterObjectCurves.h (2K, Oct. 8, 2002); filterObjectCurves.m (10K, Oct. 8, 2002); filterObjectSaturation.h (2K, Oct. 8, 2002); filterObjectSaturation.m (11K, Sep. 13, 2002); filterUnit.h (1K, Oct. 8, 2002); filterUnit.m (2K, Oct. 8, 2002); filterView.h (1K, Oct. 8, 2002); filterView.m (7K, Oct. 8, 2002); filterViewRep.h (1K, Oct. 8, 2002); filterViewRep.m (6K, Oct. 8, 2002); gradient.h (1k, Aug. 26, 2002); gradient.m (1k, Aug. 26, 2002); henry.pbxuser (22K, Oct. 8, 2002); histogram.h (1K, Oct. 8, 2002); histogram.m (3K, Oct. 8, 2002); main.m (1K, Oct. 8, 2002); myController.h (6K, Oct. 8, 2002); myController.m (49K, Oct. 6, 2002); project.pbxproj (19K, Oct. 8, 2002); seb.pbxuser (11K, Oct. 8, 2002); wb02a.pbxuser (87K, Oct. 8, 2002); wbImageview.h (2k, Aug. 26, 2002); wbImageView.m (7k, Aug. 26, 2002). As with the other software modules, the Colorwork module also may use the programs in the WBSharedLib and WBApplyColorLib directories of the computer program listing Appendix.

The Colorwork module allows a user to manipulate light, background, and skin colors. Using digital retouching tools such as curves, filters, hue, saturation, and lightness filters, the user can load test images from the shoot and apply a number of filters in order to achieve the desired “look.” With the Colorwork module, users can save “choice” color schemes and have the Boxwork module automatically apply such “choice” color schemes to all newly shot images, thus alleviating the user from having to independently load each new image into an application, such as Photoshop (available from Adobe), apply color correction to that specific image, and then save each image individually. Such a batch processing feature saves time and provides greater consistency in the changes made to multiple images.

In a preferred embodiment, the Colorwork module also provides an array of graphic aids, such as image histograms, color scales, and color measurements to help the photographer achieve the desired result.

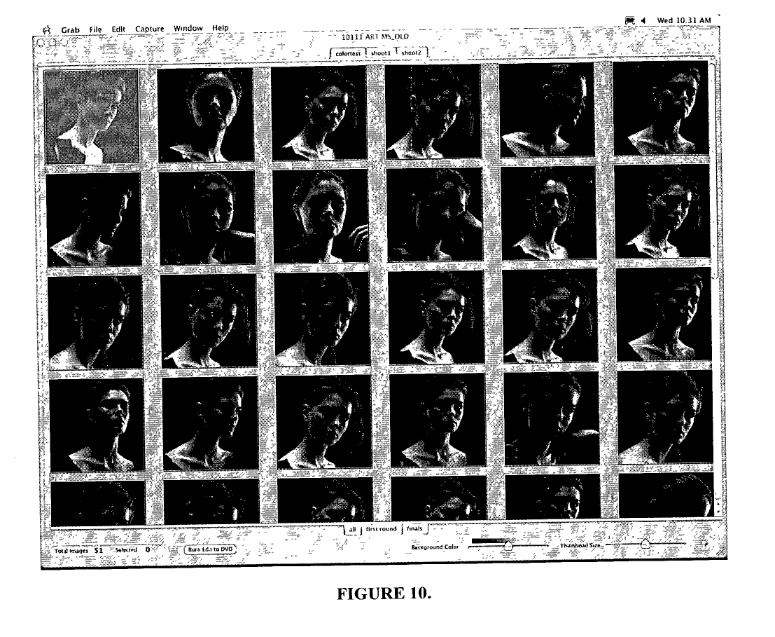

A preferred embodiment of the “Editwork” software module includes a tool which enables a user to view all the images belonging to each shot in a convenient and intuitive way. FIG. 10 is a screen shot of a preferred embodiment of the Editwork module. The component parts of a preferred embodiment of the Editwork software module are set forth in the “Editwork” directory of the computer program listing Appendix and include the following source code files: applyColorFunctions.java (1k, Aug. 27, 2002); controller.java (77K, Oct. 7, 2002); henry.pbxuser (9K, Oct. 8, 2002); imageCell.java (6K, Oct. 8, 2002); imageMatrix.java (7K, Oct. 8, 2002); jdirectFunctions.java (2k, Aug. 15, 2002); main.m (1K, Oct. 8, 2002); project.pbxproj (10K, Oct. 8, 2002); seb.pbxuser (30K, Oct. 8, 2002); sreplans.pbxuser (11K, Oct. 8, 2002); wb02a.pbxuser (81K, Oct. 8, 2002).

As with the other software modules, the Editwork module also may use the programs in the WBBSharedLib and WBApplyColorLib directories of the computer program listing Appendix.

The Editwork module allows a user to select from the hundreds or thousands of images shot, choosing only the ones that s/he feels are the best. When a user launches Editwork, the images taken with the digital camera are already color processed and organized on a per shoot basis. At this point, the user has the ability to browse the images in thumbnail form (which is a small version of the image), or enlarge the image to a full-screen preview (such as by double-clicking it).

In a preferred embodiment, a user can select “choice” shots by simply pressing one button and creating a new, smaller collection of those shots. The Editwork module essentially filters the data and takes only the “choice” images and displays only those “choice” images in a separate window. In this way, the user goes through a visual process of elimination, and can arrive at final choices through a digital, user friendly process of editing.

Once finished, these final “choices” can be saved, printed, e-mailed, and/or transferred to storage media, such as a CD or DVD, for later retrieval by the user or post-production personnel.

Most users of a system such as disclosed herein will be professional photographers hired, such as by a magazine or advertising agency, to produce images for a specific campaign. In a preferred embodiment, a software module allows the user to select the particulars of a magazine and create a layout, with the number of pages specific to the configurations. The component parts of a preferred embodiment of the “Pagework” software module are set forth in the “Pagework” directory of the computer program listing Appendix and include the following source code files: henry.pbxuser (560K, Oct. 8, 2002); myImageViewDouble.java (11K, Oct. 8, 2002); myImageViewSingle.java (14K, Oct. 8, 2002); myImageViewSingle2.java (18K, Oct. 8, 2002); myPanel.java (1K, Oct. 8, 2002); myPanel3.java (1K, Oct. 8, 2002); myPrintedDoublePage.java (4K, Oct. 8, 2002); myPrintedPage.java (3K, Oct. 8, 2002); myPrintedStoryboardPage.java (10K, Oct. 8, 2002); project.pbxproj (25K, Oct. 8, 2002); Sketch_main.m (1K, Oct. 8, 2002); SKTCircle.java (1K, Oct. 8, 2002); SKTDrawAppDelegate.java (23K, Oct. 8, 2002); SKTDrawDocument.java (42K, Oct. 8, 2002); SKTDrawWindowController.java (17K, Oct. 8, 2002); SKTGraphic.java (40K, Oct. 8, 2002); SKTGraphicView.java (74K, Oct. 8, 2002); SKTGridPanelController.java (6K, Oct. 8, 2002); SKTGridView.java (1K, Oct. 8, 2002); SKTImage.java (14K, Oct. 8, 2002); SKTInspectorController.java (19K, Oct. 8, 2002); SKTLine.java (4K, Oct. 8, 2002); SKTRectangle.java (1K, Oct. 8, 2002); SKTRenderingView.java (2K, Oct. 8, 2002) SKTTextAreajava (14K, Oct. 8, 2002); SKTToolPaletteController.java (3K, Oct. 8, 2002); wb02a.pbxuser (5K, Oct. 8, 2002).

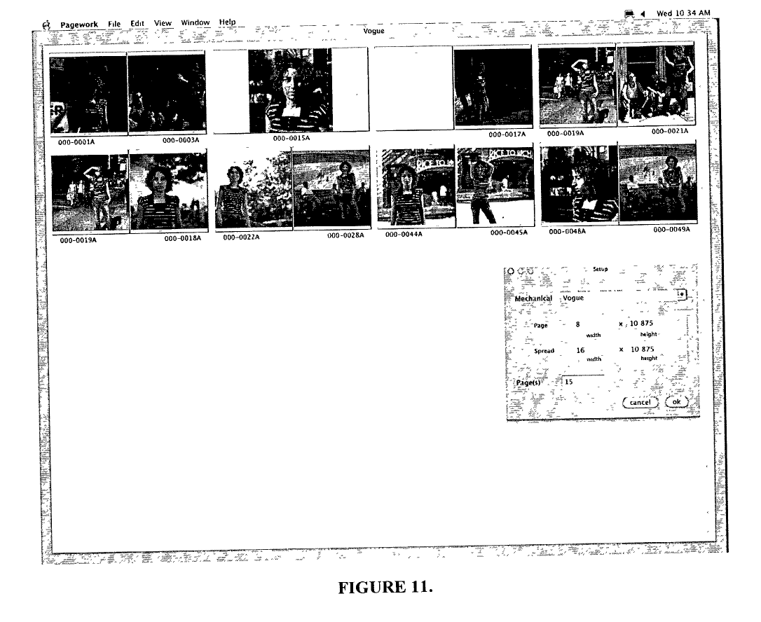

FIG. 11 is a screen shot of a preferred embodiment of the Pagework software module. As with the other software modules, the Pagework module also may use the programs in the WBSharedLib and WBApplyColorLib directories of the computer program listing Appendix.

Images can be plugged into a template and can be viewed in many different forms (as a single page, a spread, a double page, etc.). In a preferred embodiment, the Pagework module allows the user to visualize how the images will look on the magazine/advertising page(s). The Pagework module allows a user to envision the image in its final format.

In a preferred embodiment, images can be dragged into the Pagework module from the Editwork module and easily exchanged to visualize how they look together. The Pagework module has a built-in database of popular magazines with corresponding production specifications. The Pagework module allows for the scaling, rotating, cropping, and layout of images. Additionally, the Pagework module allows the composition of multiple images, text, and magazine logos into one page.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A system for processing digital pictures comprising:
a computer;
a monitor; and
software for operating the computer.
